(19) United States
(12) Patent Application Publication
(10) Pub. No.: US 2011/0254451 A1
(43) Pub. Date: Oct. 20, 2011

(54) APPARATUS AND METHOD FOR PREVENTING LAMP DAMAGE IN RAPID HEAT TREATMENT EQUIPMENT

(75) Inventors: Sang Hyun Ji, Gyeonggi-do (KR); Dae Gyou Jin, Gyeonggi-do (KR); Ki Nam Kim, Gyeonggi-do (KR)

(73) Assignee: ASIA PACIFIC SYSTEMS, INC.

(21) Appl. No.: 13/132,394

(22) PCT Filed: Nov. 27, 2009
(86) PCT No.: PCT/KR09/07051

§ 371 Date: Jul. 6, 2011

(30) Foreign Application Priority Data
Dec. 2, 2008 (KR) 10-2008-0121154

(51) Int. Cl. H05B 37/03

(52) U.S. Cl. 315/129

(57) ABSTRACT

Disclosed are an apparatus and method for preventing damage to the lamp of rapid heat treatment equipment. The most significant feature of the present invention is to provide an apparatus and method for preventing damage to a lamp in rapid heat treatment equipment, wherein the temperature of a quartz case comprising the lamp is sensed to identify an erratic increase in the temperature thereof so that problems with the lamp may be discovered early to take action. The apparatus and method according to the present invention allows the possibility of preventing damage or contamination of surrounding components due to lamp explosion; decisions regarding lamp replacement are also facilitated so that productivity can be enhanced. In addition, uniform lamp output may be ensured so that product quality is enhanced.

### TECHNICAL FIELD

The present invention relates to an apparatus and method for preventing damage of a lamp for rapid heat treatment equipment and, more particularly, to an apparatus and method for preventing damage of a lamp for rapid heat treatment equipment to minimize process interruption due to such lamp damage.

### BACKGROUND ART

Tungsten-halogen lamps used for rapid thermal process (RTP) equipment are devices that generate high energy output and lifetime thereof varies according to surrounding temperature. Among the tungsten-halogen lamps, a bulb-type lamp includes a filament disposed in a quartz case. The bulk-type lamp is well suited to ordinary situations, but is susceptible to damage due to a difference in thermal expansion between the quartz case and a connection section thereof when the surrounding temperature increases due to extended use. This causes whitening or darkening of the quartz case of the lamp, shifting transmittance of the quartz case from 95% to below 50%. Reduced transmittance causes absorption of heat emitted from the lamp by the quartz case, which results in a sharp increase in the temperature of the quartz case, causing explosion of the quartz case. If the lamp is broken, there may be a danger of short circuit with surrounding elements and of contamination due to foreign matter produced by explosion. Therefore, after lamp breakage, the surrounding elements must be cleaned, which requires considerable time and can result in degraded performance of equipment due to lamp damage.

### Disclosure

### Technical Problem

Aspects of the present invention provide an apparatus and method for preventing damage of a lamp for rapid thermal process (RTP) equipment to minimize process interruption due to the lamp damage.

### Technical Solution

In accordance with an aspect of the present invention, an apparatus for preventing damage of a lamp of rapid thermal process (RTP) equipment, in which a filament is disposed within a quartz case, includes:

a temperature detector detecting a temperature of the quartz case;

a memory storing standard data of the temperature of the quartz case according to electric power applied to the filament when the quartz case is in a normal state, with real-time data including a real-time temperature detected by the temperature detector and real-time electric power applied to the filament and corresponding to the detected temperature;

a central processing unit comparing the standard data with the real-time temperature and real-time electric power stored in the memory to determine whether the temperature of the quartz case is normal or abnormal, and, if a determination result is abnormal, generating an alarm signal; and

a display unit receiving the alarm signal from the central processing unit and displaying the alarm signal to a user.

Here, the temperature detector may be a thermocouple installed adjacent the quartz case.

In accordance with another aspect of the present invention, a method for preventing damage of a lamp for rapid thermal process (RTP) equipment, in which a filament is disposed in a quartz case, includes: detecting a temperature of the quartz case; determining whether the temperature of the quartz case is normal or abnormal; and generating an alarm signal, if the determination result is abnormal.

The step of determining whether the temperature of the quartz case is normal or abnormal may include comparing standard data of the temperature of the quartz case according to electric power applied to the filament when the quartz case is in a normal state, with real-time data including a real-time temperature detected by the temperature detector and real-time electric power applied to the filament and corresponding to the detected temperature, and determining that the temperature of the quartz case is abnormal, if a difference in the temperature between the standard data and the real-time data exceeds a predetermined value.

### Advantageous Effects

According to embodiments of the invention, the apparatus and method for preventing damage of a lamp for RTP equipment may prevent damage or contamination of surrounding elements due to explosion of the lamp. Further, the apparatus and method according to the embodiments make it easy to determine whether the lamp needs to be replaced, thereby improving productivity. In addition, the apparatus and method according to the embodiments ensure that the output of the lamp remains uniform, thereby improving product quality.

### DESCRIPTION OF DRAWINGS

FIG. 1 is a cross-sectional view of a lamp used for an apparatus for preventing damage of a lamp for RTP equipment according to an exemplary embodiment of the present invention;

FIG. 2 is a schematic view of an apparatus for preventing damage of a lamp for RTP equipment according to an exemplary embodiment of the present invention; and

FIG. 3 is a flowchart of a method for preventing damage of a lamp for RTP equipment according to an exemplary embodiment of the present invention.

### MODE FOR INVENTION

Exemplary embodiments of the invention will be described in detail. However, it will be apparent to those skilled in the art that the invention is not limited to the embodiments herein but can be implemented in various ways.

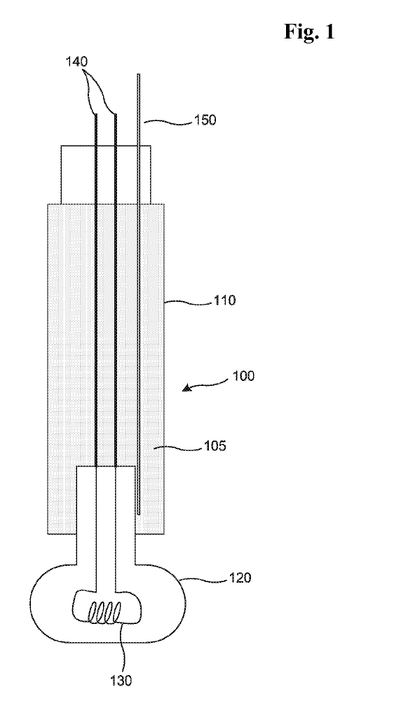

FIG. 1 is a cross-sectional view of a lamp used for an apparatus for preventing damage of a lamp for RTP equipment according to an exemplary embodiment. Referring to FIG. 1, the lamp 100 includes a filament 130 which generates heat by electric power supplied through an electric wire 140, a quartz case 120 surrounding the filament 130, and a housing 110 into which the quartz case 120 is fixedly inserted, elements of which are the same as a conventional lamp. In the embodiment of the invention, the lamp further includes a thermocouple 150, which is inserted into the housing 110 and terminates near the quartz case 120, to detect the temperature of the quartz case 120. The thermocouple 150 is fixed by a ceramic material 105 inside the housing 110 such that an end portion thereof where temperature detection occurs is located near the quartz case 120 of the lamp, thereby improving precision of temperature detection.

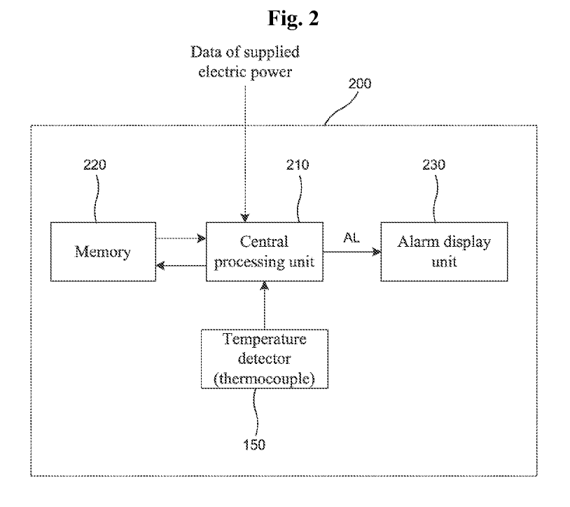

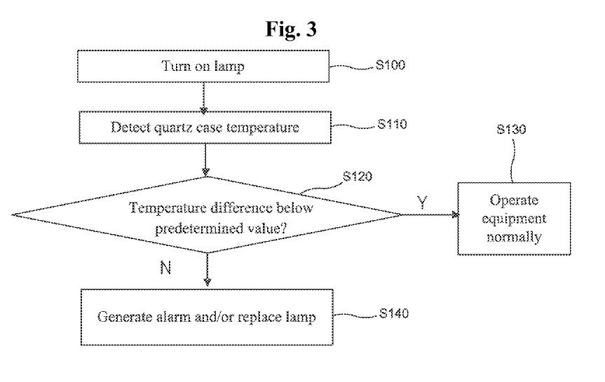

FIG. 2 is a schematic view of an apparatus for preventing damage of a lamp for RTP equipment according to an exemplary embodiment of the present invention, and FIG. 3 is a flowchart of a method for preventing damage of a lamp for RTP equipment according to an exemplary embodiment of the present invention. Referring to FIGS. 2 and 3, the apparatus 200 for preventing damage of the lamp includes a thermocouple 150, i.e. a temperature detector, a central processing unit 210, a memory 220, and an alarm display unit 230. When the lamp is turned on (S100), the thermocouple 150 detects the temperature of the quartz case (S110). The detected temperature data is stored in the memory 220 via the central processing unit 210. Here, data of electric power applied to the lamp that are generally input to the central processing unit are also stored in the memory 220. In the memory 220, real-time data of the temperature detected in real-time and real-time data of the electric power supplied to the lamp are also stored. The memory also stores standard data of the temperature of the quartz case according to electric power applied to the filament when the quartz case is in a normal state. The standard temperature and electric power data and the real-time temperature and electric power data are compared and determined by the central processing unit 210 such that the central processing unit checks a difference in temperature between the standard data and the real-time data, and if the difference exceeds a predetermined value, the central processing unit determines that the detected temperature is abnormal (S120). If the difference is below the predetermined value, it is determined that the detected temperature is normal, and the central processing unit 210 controls the equipment to operate normally (S130). If the detected temperature is determined abnormal, the central processing unit 210 generates an alarm signal (AL) and displays the alarm on the alarm display unit 230 so as to inform the user that the lamp is in an abnormal state such that the user takes measures such as replacement of the lamp (S140). Such an alarm display unit 230 may include a display, lamp, speaker, and the like.

1. An apparatus for preventing damage of a lamp for rapid thermal process (RTP) equipment, in which a filament is disposed within a quartz case, comprising:
a temperature detector detecting a temperature of the quartz case;
a memory storing standard data of the temperature of the quartz case according to electric power applied to the filament when the quartz case is in a normal state, with real-time data including a real-time temperature detected by the temperature detector and real-time electric power applied to the filament and corresponding to the detected temperature;
a central processing unit comparing the standard data with the real-time temperature and real-time electric power stored in the memory to determine whether the temperature of the quartz case is normal or abnormal, and, if a determination result is abnormal, generating an alarm signal; and
a display unit receiving the alarm signal from the central processing unit and displaying the alarm signal to a user.

2. The apparatus of claim 1, wherein the temperature detector is a thermocouple installed adjacent the quartz case.

3. The apparatus of claim 1, wherein the alarm display unit comprises a display device, lamp or speaker.

4. A method for preventing damage of a lamp for rapid thermal process (RTP) equipment, in which a filament is disposed within a quartz case, the method comprising:
detecting a temperature of the quartz case;
determining whether the temperature of the quartz case is normal or abnormal; and
generating an alarm signal, if the determination result is abnormal.

5. The method of claim 4, wherein the step of determining whether the temperature of the quartz case is normal or abnormal comprises: comparing standard data of the temperature of the quartz case according to electric power applied to the filament when the quartz case is in a normal state, with real-time data including a real-time temperature detected by the temperature detector and real-time electric power applied to the filament and corresponding to the detected temperature, and determining that the temperature of the quartz case is abnormal, if a difference in the temperature between the standard data and the real-time data exceeds a predetermined value.
